(19) United States
(12) Patent Application Publication
(10) Pub. No.: US 2005/0203798 A1
(43) Pub. Date: Sep. 15, 2005

(54) Methods and systems for gathering market research data

(76) Inventors: James M. Jensen, Columbia, MD (US); Eugene L. Flanagan III, Wilton, CT (US)

Correspondence Address: EUGENE L. FLANAGAN III;COWAN , LIEBOWITZ & LATMAN, P.C., 1133 AVENUE OF THE AMERICAS, NEW YORK, NY, 10036-6799, US

(21) Appl. No.: 10/800,883

(22) Filed: Mar. 15, 2004

(51) Int. Cl. G06F 17/60

(52) U.S. Cl. 705/14

(57) ABSTRACT

Methods and systems for monitoring exposure of participants in market research to predetermined products, for example, within a commercial establishment, are provided. The methods and systems employ portable monitors carried on the persons of the participants to gather product exposure data.

### FIELD OF THE INVENTION

The present invention relates to market research methods and systems which gather data concerning the exposure of panelists to predetermined products.

### BACKGROUND OF THE INVENTION

Manufacturers and distributors of products, as well as service providers, expend substantial amounts in advertising and promotional activities for the purpose of stimulating interest in their products and services among consumers. They review sales volume information as well as more detailed purchasing information such as the demographic characteristics of those who purchase their products and services in order to select those advertisements and promotional activities which seem best suited to influence consumers to purchase their products and services.

It is desired, however, to obtain more detailed information concerning the effectiveness of advertising and promotional expenditures, and in particular to assess their effectiveness in stimulating initial interest in products and services among consumers whether or not they purchase them, since factors apart from advertising and promotion, such as price, affect the decision to purchase.

### SUMMARY OF THE INVENTION

For this application the following terms and definitions shall apply:

The term “data” as used herein means any indicia, signals, marks, symbols, domains, symbol sets, representations, and any other physical form or forms representing information, whether permanent or temporary, whether visible, audible, acoustic, electric, magnetic, electromagnetic or otherwise manifested. The term “data” as used to represent predetermined information in one physical form shall be deemed to encompass any and all representations of the same predetermined information in a different physical form or forms.

The term “media data” as used herein means data which is widely accessible, whether over-the-air, or via cable, satellite, network, internetwork (including the Internet), distributed on storage media, or otherwise, without regard to the form or content thereof, and including but not limited to audio, video, text, images, animations, web pages and streaming media data.

The term “database” as used herein means an organized body of related data, regardless of the manner in which the data or the organized body thereof is represented. For example, the organized body of related data may be in the form of a table, a map, a grid, a list or in any other form.

The term “location” as used herein refers to a position relative to a commercial establishment, a product display, a product, another object or facility, or relative to a coordinate system such as latitude and longitude.

The term “layout map” as used herein means a database of data representing locations in an area or areas for purposes of market research.

The term “network” as used herein includes both networks and internetworks of all kinds, including the Internet, and is not limited to any particular network or inter-network.

The terms “first” and “second” are used to distinguish one element, set, data, object or thing from another, and are not used to designate relative position or arrangement in time.

The terms “coupled”, “coupled to”, and “coupled with” as used herein each mean a relationship between or among two or more devices, apparatus, files, programs, media, components, networks, systems, subsystems, and/or means, constituting any one or more of (a) a connection, whether direct or through one or more other devices, apparatus, files, programs, media, components, networks, systems, subsystems, or means, (b) a communications relationship, whether direct or through one or more other devices, apparatus, files, programs, media, components, networks, systems, subsystems, or means, and/or (c) a functional relationship in which the operation of any one or more devices, apparatus, files, programs, media, components, networks, systems, subsystems, or means depends, in whole or in part, on the operation of any one or more others thereof.

The terms “communicate” and “communication” as used herein include both conveying data from a source to a destination, and delivering data to a communications medium, system or link to be conveyed to a destination.

The term “processor” as used herein means processing devices, apparatus, programs, circuits, systems and subsystems, whether implemented in hardware, software or both.

The terms “storage” and “data storage” as used herein mean data storage devices, apparatus, programs, circuits, systems, subsystems and storage media serving to retain data, whether on a temporary or permanent basis, and to provide such retained data.

In accordance with an aspect of the present invention, a method is provided for monitoring exposure to a product of a participant in market research. The method comprises providing a portable monitor comprising a wireless receiver to a respective participant selected from a plurality of participants in the market research study, the portable monitor being adapted to be carried on the person of a participant; detecting product data in the portable monitor, the product data being contained in a product signal received in the wireless receiver from a predetermined signal transmitter proximal to a respective product, the product data representing the respective product, the product signal having a signal strength selected so that the product data is detectable by the portable monitor only when in a predetermined proximity to the predetermined signal transmitter; and storing the product data in the portable monitor.

In accordance with a further aspect of the present invention, a device is provided for monitoring exposure to products by participants in market research. The device comprises a portable monitor adapted to be carried on the person of a participant in the market research study, the portable monitor comprising a wireless receiver operative to receive a product signal from a predetermined signal transmitter proximal to a respective product, the product signal containing product data representing the respective product, the wireless receiver having a sensitivity selected so that the portable monitor is capable of detecting the product data in the product signal only when in a predetermined proximity to the predetermined signal transmitter; and a data storage coupled with the wireless receiver to receive and store the product data.

In accordance with another aspect of the present invention, a system is provided for monitoring exposure of a participant in market research to a predetermined product. The system comprises a database storing product location data representing a location of a predetermined product; a portable monitor adapted to be carried on the person of a participant in market research and comprising a position monitor operative to produce participant location data representing a location of the participant and a data storage coupled with the position monitor to receive the participant location data and operative to store the participant location data; and a processor coupled with the portable monitor to receive the participant location data therefrom and operative to access the product location data from the database; the processor serving to process the participant location data and the product location data produce product proximity data indicating exposure of the participant to the predetermined product.

### BRIEF DESCRIPTION OF THE DRAWINGS

FIG. 1 is a schematic diagram of an aisle in a retail store for use in illustrating certain embodiments of the present invention;

FIG. 1A is a block diagram illustrating a wireless transmitter of FIG. 1 in cooperation with an intelligent shelf system to gather product data therefrom;

FIG. 2 illustrates a table of a relational database in accordance with certain embodiments of the present invention;

FIG. 3 illustrates a method and system for monitoring exposure of a panelist participating in market research to a product in or on a promotional display in accordance with certain embodiments of the present invention;

FIG. 4 provides block diagrams of certain embodiments of signal transmitters and a portable monitor arranged to be carried on the person of a panelist, in accordance with certain embodiments of the present invention;

FIG. 5 illustrates use of the portable monitor of FIG. 4 for measuring exposure of the panelist carrying the portable monitor to a media display in accordance with certain embodiments of the present invention;

FIG. 6 is a block diagram of a system for downloading data gathered by the portable monitor of FIG. 4 to a centralized processor;

FIG. 7 illustrates a further table of the relational database including the table of FIG. 2 in accordance with certain embodiments of the present invention;

FIG. 8 provides block diagrams of certain embodiments of a location signal transmitter and portable monitor wherein the portable monitor tracks its location using an inertial monitoring device.

### DETAILED DESCRIPTION OF CERTAIN ADVANTAGEOUS EMBODIMENTS

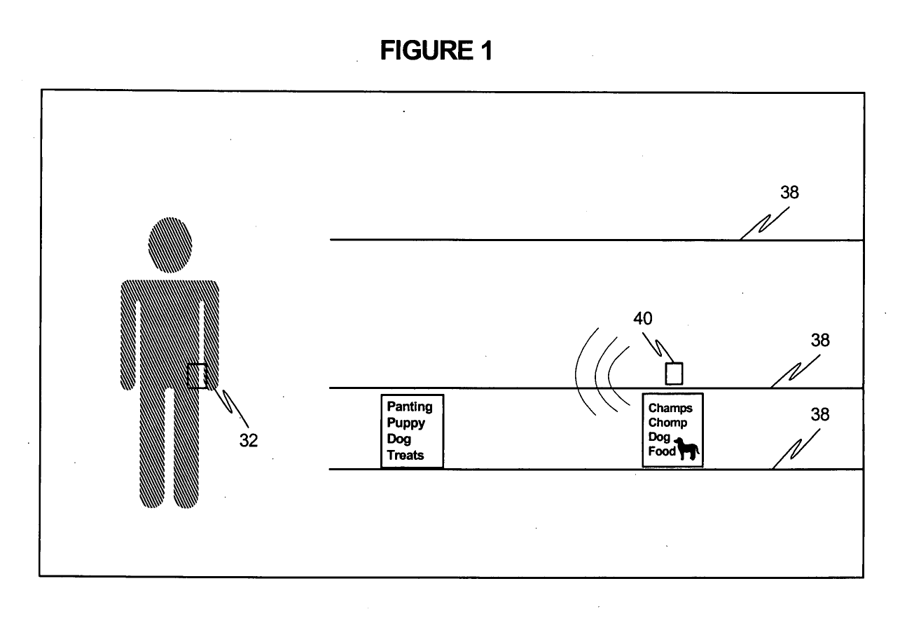

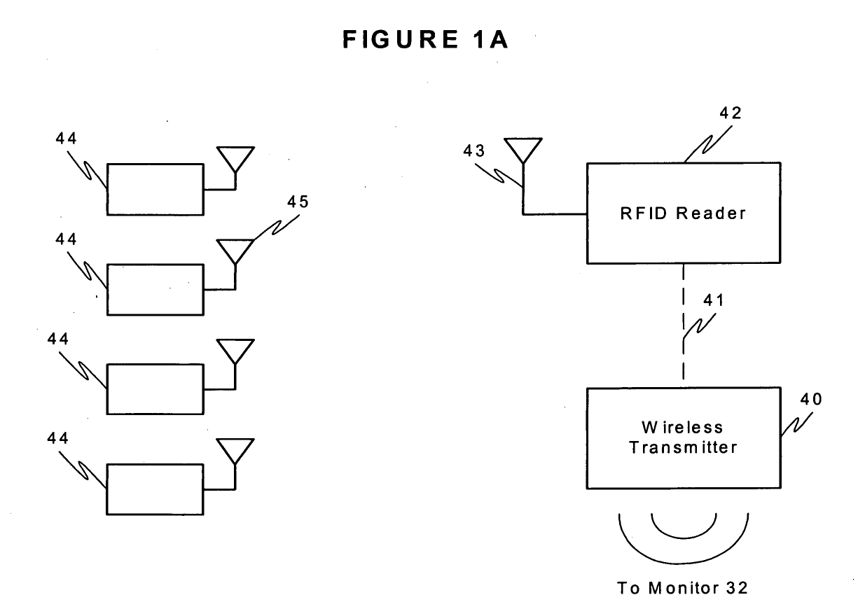

The present invention is useful for monitoring the exposure of customers to products, but is particularly useful for gathering such data in retail stores as well as in all other kinds of commercial establishments. FIG. 1 schematically illustrates an aisle of a retail store adjacent a group of shelves 38 on which products are arranged for sale. A portable monitor 32 is carried on the person of a panelist participating in a market research study to monitor the exposure of the panelist to various predetermined products.

An RF transmitter 40 is placed in the vicinity of a particular product offered for sale, here indicated as a fictitious product, Champs Chomp dog food. The RF transmitter 40 transmits a product signal containing data identifying the product of interest, its manufacturer, distributor and/or otherwise containing data corresponding to the product. Such data in certain embodiments comprises a transmitter identification code that uniquely identifies the transmitter 36, and from which data relating to the product can be obtained. In certain embodiments the product signal includes commercial establishment data identifying or otherwise relating to the commercial establishment in which the panelist is present. In certain embodiments, the commercial establishment data directly identifies the commercial establishment, while in others the commercial establishment data is used to access or derive such identity. In certain embodiments, the commercial establishment data relates to the commercial establishment, with or without identifying it directly or indirectly. The frequency or frequencies of the product signal can be selected from any permissible frequency range, up to and including microwave frequencies.

As the panelist wearing the portable monitor 32 draws near to the product, the monitor 32 receives the product signal and detects the data contained therein. The strength of the transmitted product signal, along with the sensitivity of the monitor 32 are selected to ensure that monitor 32 will only detect the data contained in the product signal when it is sufficiently near the predetermined product for the purposes of the study. In certain advantageous embodiments, one or both of the strength of the location signal and the sensitivity of the monitor are selected to ensure that the monitor 32 will only detect the data in the product signal when the monitor is located within a predetermined area to be monitored, such as a predetermined area in which the predetermined product or a product display containing the product can be perceived by the panelist. When the monitor 32 detects the data contained in the product signal, it stores either the data or data based thereon, together with a time stamp indicating the time at which the data was received.

If the panelist lingers in the vicinity of transmitter 40, this indicates that the panelist may be interested in purchasing the adjacent product. Accordingly, periodically or from time to time the monitor 32 checks for the detection of the data contained in the same or a different product signal. If the data of the same product signal has again been detected, the monitor 32 stores further data indicating a duration of the continuous presence of the panelist in the vicinity of transmitter 40.

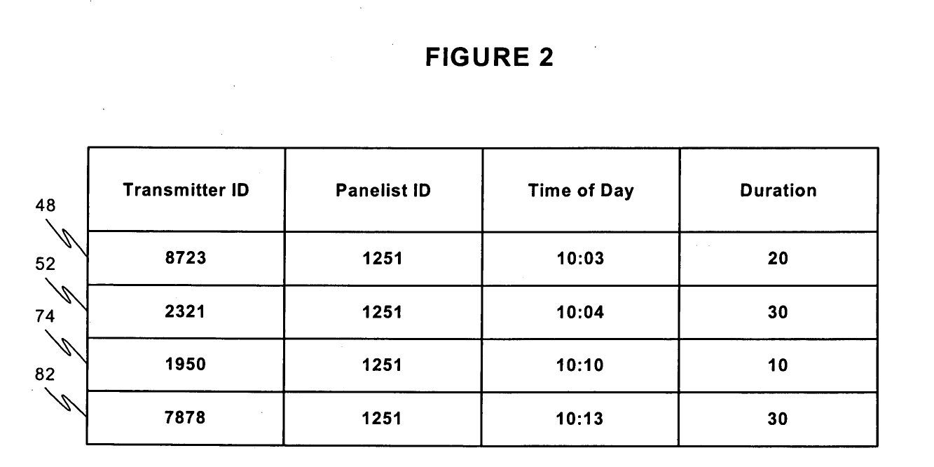

In certain embodiments, the transmitter 40 cooperates with an intelligent shelf system of the commercial establishment to gather product data. FIG. 1A illustrates such a cooperative relationship, in which the wireless transmitter 40 communicates with an RFID reader system 42 through a wired or wireless communications link 41 to obtain the product data therefrom. The RFID reader 42 gathers data identifying or otherwise relating to products on its shelf or other product presentation device, so that the product data is maintained up-to-date despite stocking or removal of products. Fro this purpose, the reader 42 transmits an RF signal to RFID tags (symbolized by antennas 45 in FIG. 1A) associated with various products 44 on its shelf or other device to energize or trigger them to respond with product data. When the monitor 32 comes within range of the wireless transmitter 40, it communicates the up-to-date product data thereto.

Where the product signal transmitted by the transmitter 40 contains transmitter identification data, this transmitter identification data is also stored in a database where it is associated with data identifying the product or otherwise relating to it. FIG. 2 illustrates an embodiment of a table storing the data detected by the monitor 32 from various product signals, together with time stamps indicating a time of detection of the data and the duration of continuous detection of the same data. In the exemplary table of FIG. 2, each row represents a record of the detection of the data from a respective transmitter, here represented as a transmitter ID, along with a monitor ID (which corresponds to the panelist to whom the particular monitor has been assigned), the time at which the data from that transmitter was first detected and a duration of continuous detection of the data from such transmitter. In certain other embodiments the data detected by the monitor is stored without the monitor ID which is not associated with the other stored data until it has been downloaded from the monitor 32.

A first record 48 of the FIG. 2 table is an example of the data stored by portable monitor 32 upon detection of the data contained in the product signal received from transmitter 40 (having transmitter ID 8723) when the panelist approaches the transmitter 40 and its corresponding product. Here the record indicates that the panelist remained for 20 seconds indicating interest in Champs Chomp dog food in Ed's Emporium.

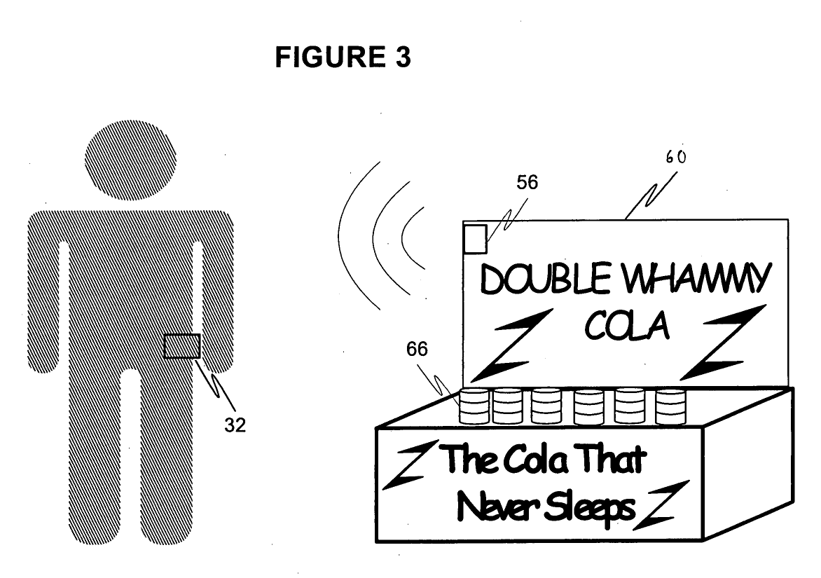

A further record 52 of the FIG. 2 table represents data gathered by the monitor as the panelist pauses in the vicinity of a transmitter 56 (having transmitter ID 2321) shown in FIG. 3 mounted on an in-store product display 60 for a fictitious soft drink product, Double Whammy cola. As shown in FIG. 3, the product display 60 serves to attract attention to the product 66 which it carries or contains. As the panelist stops by the product display 60, the monitor records data indicating the duration of the panelist's presence near the product display providing an indication of its effectiveness in attracting consumer attention.

As the panelist proceeds through the store, the monitor 32 detects data contained in further product signal indicating that the panelist has approached another predetermined product involved in the study. The detected data is stored by the monitor 32 in a record such as exemplary record 74 shown in FIG. 3. Still later the panelist pauses in the vicinity of another to examine still another product involved in the study, as indicated by record 82 in FIG. 3.

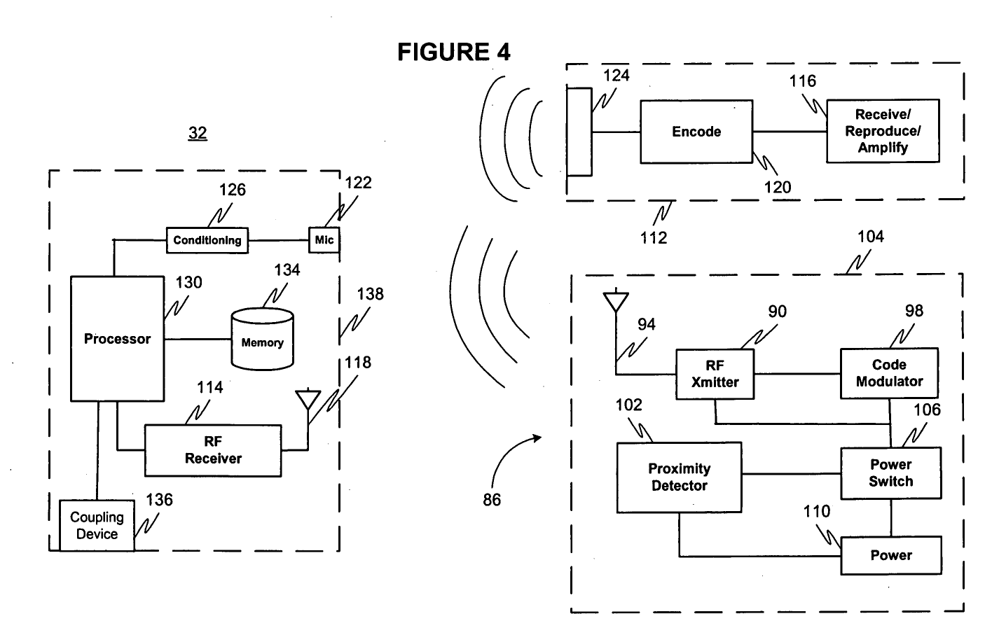

FIG. 4 provides a block diagram of certain embodiments of the portable monitor 32, along with a block diagram 86 of certain embodiments of the transmitter 40. In the diagram 86, an RF transmitter 90, antenna 94, code modulator 98, proximity detector 102, power switch 106 and power source 110 are enclosed or carried within a container 104. The container 104 preferably is small and otherwise inconspicuous, so that it is unnoticed by panelists and thus does not influence their behavior. In certain embodiments, the transmitters are contained in a thin laminated package that can be affixed inconspicuously to the bottom of a store shelf. In others they are carried in a small housing or encapsulated in molded plastic.

In the transmitter embodiment 86, power from the power source 110 is only applied to the RF transmitter 90 and code modulator 98 when the proximity detector 102 detects the presence of a person in proximity to the transmitter 86 and turns on the normally off power switch 106. The proximity detector 102 senses a selected form or forms of data indicating the presence or approach of a person, such as changes or levels of infrared, thermal, light, or electrical energy, and then provides a switching signal to power switch 106 to turn it on. In certain embodiments an external switch is employed to switch on power, such as a pressure sensitive switch activated by the panelist's footstep or a doorway switch actuated by opening a door or passing through a doorway. Preferably power switch 106 remains on only long enough to ensure that a detectable product signal is transmitted to any monitor 32 that may be carried by a panelist nearby, so that power from the source 110 is conserved to ensure the continuing ability of the transmitter 86 to function. As an example only, in certain embodiments the power switch applies power continuously for 30 seconds after receipt of the switching signal and then automatically resets to an off state, so that the product signal is transmitted continuously for such 30 second period. In certain embodiments, the transmitter has two operational states, a standby, low power mode in which it does not transmit and a transmit mode in which it does. In such embodiments, the switch 106 or other circuitry switches the transmitter from the standby mode to the transmit mode when a person's proximity is detected.

The RF transmitter 90 drives antenna 94 to transmit an RF product signal within an appropriate band selected as any permissible RF band up to and including microwave frequencies. In certain embodiments the RF transmitter 90 produces the product signal in an unlicensed 900 MHz band and at a sufficiently low power level so that its data will be detectable by monitor 32 only within a relatively short range.

The data contained by the product signal is produced by code modulator 98 and applied as a modulating signal by code modulator 98 to RF transmitter 90. The product signal can be modulated in any manner that is compatible with the detection capabilities of portable monitor 32, such as by amplitude, frequency, pulse or phase modulation or any combination thereof. In certain embodiments the data is simply represented by the frequency of the product signal, so that a separate code modulator is not required. In certain embodiments, the data modulates the product signal to produce a periodically repeating code. As an example, such a code could repeat every 10 seconds during the transmission of the product signal, although a different repetition rate could be selected depending on the amount of data that must be transmitted and the detection error rate of the personal monitor 32 within the desired detection area.

The power source 110 is selected as one that is capable of supplying sufficient power for a desired duration, such as the duration of the marketing study. The power source 110 in certain embodiments is selected as a rechargeable battery, a non-rechargeable battery, an energy storage device, a photoelectric power source and/or a different energy receiving device such as an antenna receiving energy from the portable monitor 32 or other external source.

In certain embodiments rather than transmit upon detection of a person in proximity to the transmitter 86, the RF transmitter 90 transmits the product signal periodically. In still other embodiments the RF transmitter 90 transmits the product signal in response to a query signal transmitted from a transmitter included in the portable monitor 32 (not shown for purposes of simplicity and clarity). In certain embodiments, the transmitter is an RFID tag that receives a read signal from the monitor 32, and uses the energy of the received read signal to encode its data and retransmit the encoded data as a location signal. In certain ones of such embodiments, the RFID tag is affixed to the product itself or its packaging. In embodiments which employ RFID tags, it is advantageous to selectively key the monitor on to transmit such read signal as infrequently as possible, due to the relatively large amount of energy that must be transmitted by the monitor 32 to energize the RFID tag to retransmit a detectable product signal. For this purpose, in certain embodiments a transmitter is provided in or near the commercial establishment to key the monitor to transmit the read signal.

In certain embodiments, one or more RF energy emitters separate from the monitors 32 are placed in or near the store or other commercial establishment to emit RF energy to be received by one or more nearby RFID tags in order to energize them to transmit their codes. When a panelist carrying a monitor 32 comes within range of one of such RFID tags, the monitor detects its code and stores appropriate data. In certain embodiments, the RF energy emitters emit RF energy continuously. In others, the RF energy emitters emit RF energy periodically, from time to time, at certain times or during certain time periods. In still other embodiments, the RF energy emitters emit RF energy upon detecting either a presence of a person or of a monitor 32.

In still other embodiments, transmitters provided with an active power source, such as a battery, photoelectric cell or the like, are affixed to the product itself or its packaging, rather than attached to or placed on or in a nearby shelf or other fixture.

In other embodiments in place of an RF transmitter 90, the transmitter 86 employs a different type of wireless transmitter, such as an infrared, visible light or acoustic transmitter. An appropriate acoustic product signal emitter for this purpose is disclosed in U.S. published patent application 20030171833 A1 in the names of Jack C. Crystal and James M. Jensen, assigned to the assignee of the present application and hereby incorporated in its entirety herein by reference.

FIG. 4 also provides a block diagram of an embodiment of the portable monitor 32 which includes an RF receiver 114, an antenna 118, a microphone 122, conditioning circuitry 126, a processor 130, a memory 134, a coupling device 136 and an enclosure 138 containing all of the foregoing elements of portable monitor 32. The enclosure preferably is sufficiently small to permit the portable monitor 32 to be carried in or on an article of clothing worn by the panelist, such as a belt, pocket, collar or lapel, or on the panelist's wrist or elsewhere. In certain embodiments the enclosure 138 is provided with a clip, loop, necklace, band, pin or other device (not shown for purposes of simplicity and clarity) to affix or hang the monitor 32 to or from such an article of clothing or to the panelist's wrist, neck or elsewhere. In certain embodiments, the enclosure 138 has a size and shape similar to a pager, or cellular telephone. In certain embodiments, enclosure 138 has a size and shape similar to a credit card or smart card, so that it can be carried in a panelist's pocket or wallet or attached to a keychain. In still other or related embodiments, the enclosure 138 takes the form of a wristwatch, wristlet, card case, key fob, change purse, article of jewelry or other decorative or useful article, or else is adapted to be carried by or attached to one or more of the foregoing.

RF receiver 114 has an input coupled with antenna 118 to receive the product signal and is operative to detect the data therein and supply it at an output coupled with processor 130 in a form suitable for input to the processor 130. Preferably, the receiver 114 is operated only periodically, or from time to time, in order to conserve power in the portable monitor 32. For example, in certain embodiments the receiver 144 is turned on for a 10 second period during a repeating 30 second interval.

Where the transmitter 86 transmits the product signal in a different form, such as infrared or visible light, wireless receiver 114 and antenna 118 are replaced in other embodiments of the portable monitor 32 by a suitable light sensor and conditioning circuitry coupled with the light sensor and operative to detect the data contained in the product signal and supply it in a suitable form to the processor 130. Where the transmitter 86 instead transmits an acoustic product signal, in certain embodiments of portable monitor 32 the microphone 122 and conditioning circuitry 126 serve to receive the product signal and supply it in suitable form to the processor 130. In certain ones of such embodiments the processor 130 serves to detect the data contained in the product signal transmitted in acoustic form.

The processor 130 is also operative to store the detected product data with a time stamp produced by processor 130 or else by a separate clock (not shown for purposes of simplicity and clarity). Where the processor continues to detect the same product signal data, in certain embodiments it produces duration data indicating a duration of continuous receipt of the same product signal data and stores it in association with the location data and time stamp. In certain other embodiments, in place of duration data, the processor instead stores an ending time stamp representing a point in time when it no longer continues to receive the same product signal data. In still other embodiments, the processor simply stores each detection of the product signal data with a respective time stamp associated therewith.

The embodiments of portable monitor 32 illustrated in FIG. 4 also serve to monitor exposure of the panelist to media data having an acoustic component, such as radio and television broadcasts, prerecorded content and streaming media. This is achieved in certain embodiments by processing acoustic data received by microphone 122 in processor 130. Processor 130 analyzes the acoustic data to detect the presence of an ancillary code therein or to extract a signature therefrom, which can be used to identify or otherwise characterize the media data. Suitable analysis techniques are disclosed in published U.S. patent application 20030005430 A1 in the name of Ronald S. Kolessar assigned to the assignee of the present invention and hereby incorporated herein by reference in its entirety. The monitor 32 stores such media data exposure data in storage 134 together with time stamps representing timing of exposure thereto. Preferably, the time stamp is obtained from the same source as that stored with the data indicating detection of the product signal data so that the time stamps are all on the same predetermined time base.

In certain embodiments, a commercial establishment signal is transmitted to the monitor 32 by a transmitter other than those employed as in FIG. 1 to represent particular products within a store or other commercial establishment. Such a transmitter used to transmit a commercial establishment signal, containing data such as store identification data, store location data or other data representing a commercial establishment, comprises an RF transmitter in certain embodiments, and in others comprises a light signal transmitter which transmits infrared or visible light.

In still other embodiments, an acoustic transmitter is employed to transmit the commercial establishment signal. An embodiment of such an acoustic transmitter is illustrated in FIG. 4 as acoustic transmitter 112. Acoustic transmitter 112 is positioned to emit acoustic energy such as broadcast, streaming or reproduced audio (for example, music) and/or public address audio (such as announcements to shoppers), within the commercial establishment, such as store 10. A source of such audio is represented by device 116 of transmitter 112.

Acoustic transmitter 112 also comprises an encoder 120 which receives the audio from source 116 and encodes the commercial establishment data therein. Encoder 120 evaluates the ability of the received audio to mask the data when encoded in the audio and produces or adjusts the level, frequency, phase and/or other characteristic of the data to be encoded or as encoded, so that the code is inaudible when the audio is reproduced as sound. The encoded audio is output by the encoder 120 to a speaker 124 which emits the encoded audio as acoustic energy.

The encoder 120 in certain embodiments comprises an encoder of the kind disclosed in U.S. patent application Ser. No. 10/302,309 in the names of James M. Jensen and Alan R. Neuhauser, assigned to the assignee of the present application and incorporated herein by reference in its entirety and/or of the kind disclosed in U.S. Pat. No. 5,764,763 in the names of James M. Jensen, et al, assigned to the assignee of the present application and incorporated herein by reference in its entirety.

In certain embodiments the audio supplied from the source 116 is already encoded with the commercial establishment signal, for example, by encoding the audio and storing it for later reproduction. In still other embodiments, rather than encode an audio signal the acoustic transmitter samples the ambient acoustic energy to evaluate its ability to mask the commercial establishment signal and emits the commercial establishment signal having appropriate characteristics to ensure that the ambient acoustic energy will mask it. Embodiments of such acoustic transmitters are disclosed in U.S. published patent application 20030171833 A1, mentioned above.

In certain embodiments of the present invention which employ acoustic transmitters to transmit product signals and/or commercial establishment signals, the personal monitor 32 employs the microphone 122 to receive such acoustic signals and detects the data therein by means of the processor 130. In certain ones of such embodiments, the processor 130 advantageously employs a detection technique disclosed in U.S. Pat. No. 5,764,763, mentioned above, to detect the data encoded in the various acoustic signals.

In certain embodiments, acoustic transmitters are employed both to emit product signals within a commercial establishment, but also to transmit a commercial establishment signal. In such embodiments it is possible to dispense with the use of an RF receiver in monitor 32.

In certain embodiments wherein the product signal transmitters comprise acoustic transmitters, the acoustic transmitters transmit acoustic signals containing both product data and commercial establishment data to the monitor 32 which detects and stores both of these data from the received acoustic signal. In certain advantageous embodiments, both the product data and the commercial establishment data are encoded and detected according to techniques disclosed in U.S. patent application Ser. No. 10/302,309, mentioned above. In one such encoding technique, the product data and commercial establishment data are transmitted repeatedly, but each has a different duration. The monitor 32 employs two accumulators, one of which is a register having a length selected to accumulate the product data and the other of which is a different register having a length selected to accumulate the commercial establishment data. Although components of each of the data are accumulated in both registers, a register having a length selected to accumulate the product data, for example, will additively accumulate components of the product data, but will not accumulate corresponding components of the commercial establishment data, so that the commercial establishment data will appear as noise in this register.

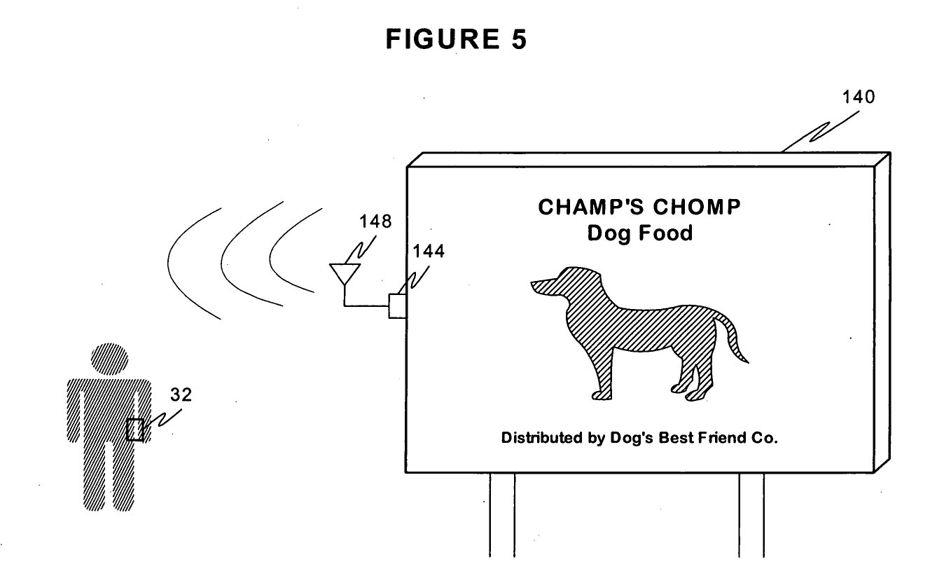

In certain embodiments portable monitor 32 serves to monitor exposure to outdoor advertising in settings such as highways, railways, and walkways, malls, subways, railway stations, bus stations, airports and building lobbies. FIG. 5 illustrates a use of monitor 32 for this purpose, in particular, to monitor exposure of a panelist carrying portable monitor 32 to a billboard advertisement, in FIG. 5 shown as an advertisement 140 for a fictitious dog food product. In the embodiment of FIG. 5, an RF transmitter 144 drives an antenna 148 to transmit a billboard proximity signal at a power level chosen to ensure that billboard proximity data contained in the signal can only be detected by portable monitor 32 when it is positioned at a location from which the panelist can view the billboard advertisement. The billboard proximity data is stored by the monitor 32 along with a time stamp representing a time of exposure to the billboard advertisement 140. Preferably, the time stamp is obtained from the same source as that stored with the data indicating detection of the product signal data so that the time stamps are all on the same predetermined time base.

In certain embodiments receiver 114 of portable monitor 32 is arranged to receive the billboard proximity signal and detect the billboard proximity data therein. In other embodiments, a different wireless receiver is included in monitor 32 for this purpose. Further embodiments of media display exposure monitoring means suitable for use in monitor 32 are disclosed in U.S. patent application Ser. No. 10/329,132 in the names of Jack K. Zhang, Jack C. Crystal and James M. Jensen, assigned to the assignee of the present application and hereby incorporated by reference herein in its entirety. Still further embodiments of media display exposure monitoring means suitable for use in monitor 32 are disclosed in U.S. patent application Ser. No. 10/640,104 in the names of Jack K. Zhang, Jack C. Crystal, James M. Jensen and Eugene L. Flanagan III, assigned to the assignee of the present application and hereby incorporated by reference herein in its entirety.

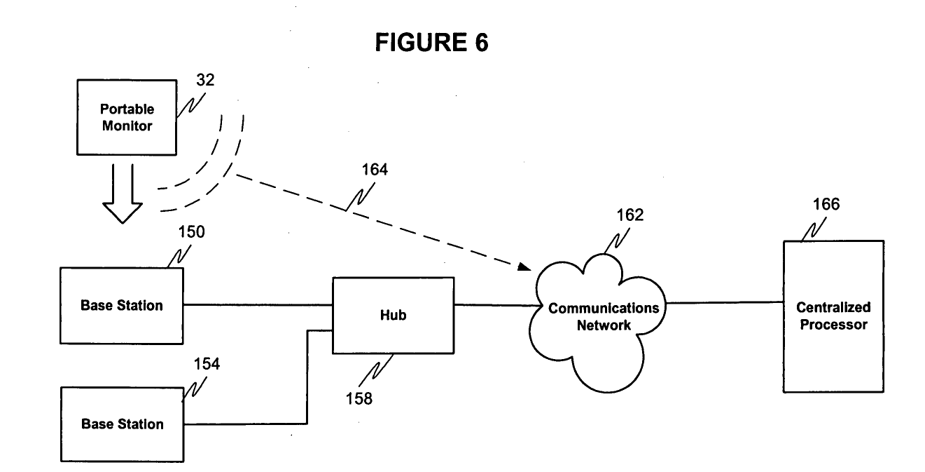

FIG. 6 illustrates a system for communicating the data stored in the personal monitor 32, as well as other personal monitors 32 assigned to other members of the same household acting as panelists in the same study, to a centralized processor 166 for use in producing reports of interest to store managers, distributors, manufacturers, other advertisers, media organizations, etc. In certain embodiments, from time to time, or periodically, each panelist in the household docks his/her portable monitor 32 in a respective base station 150, 154 to download data stored in the portable monitors. The monitor 32 communicates with the base station by means of the coupling device 136 (see FIG. 4), which in certain embodiments is an optoelectronic coupling device. In certain embodiments, the monitor communicates with the base station by means of an RF transceiver or other wireless transceiver (not shown for purposes of simplicity and clarity) without docking the monitor in the base station. This communication is initiated either by the monitor 32 or the base station 150, 154, periodically, at a predetermined time or from time to time. In certain further embodiments, the portable monitor 32 comprises a wireless network transceiver (not shown for purposes of simplicity and clarity) to establish a wireless link 164 to the communications network 162 to download data, using a WiFi or other wireless networking protocol. In still further embodiments, the portable monitor 32 comprises a cellular telephone module (not shown for purposes of simplicity and clarity) to establish a wireless link with a telephone network to download data.

Once the data has been downloaded, the memory 134 of the monitor 32 is reset to store further data. The base stations may be, for example, those disclosed in U.S. Pat. No. 5,483,276 to Brooks, et al., assigned to the assignee of the present invention and hereby incorporated herein by reference in its entirety. The base stations 150, 154 communicate with a communications hub 158 also located in the household for communication via a network 162 to the centralized processor 166 located remotely from the household. The centralized processor 166 likewise receives data from other panelists' households to produce reports as mentioned above.

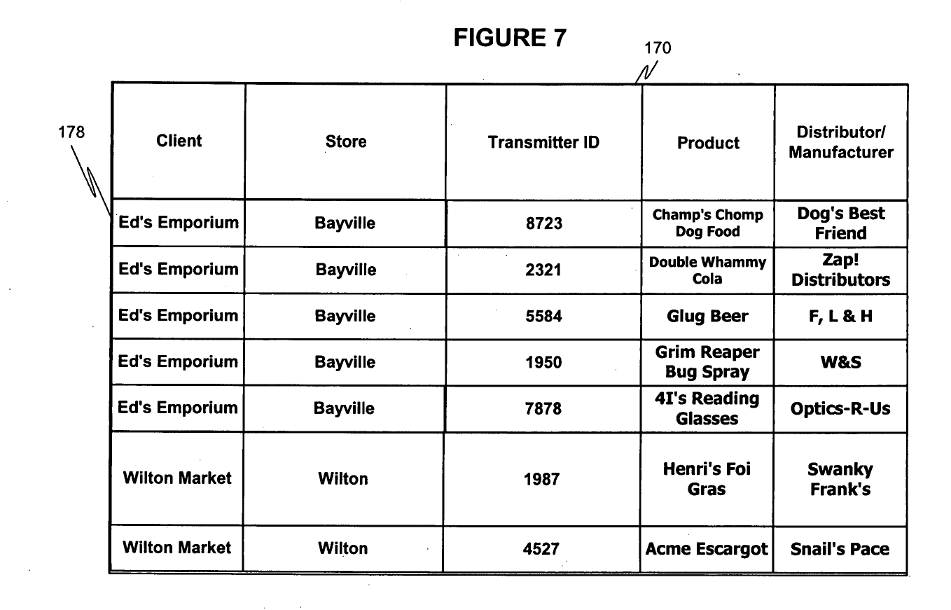

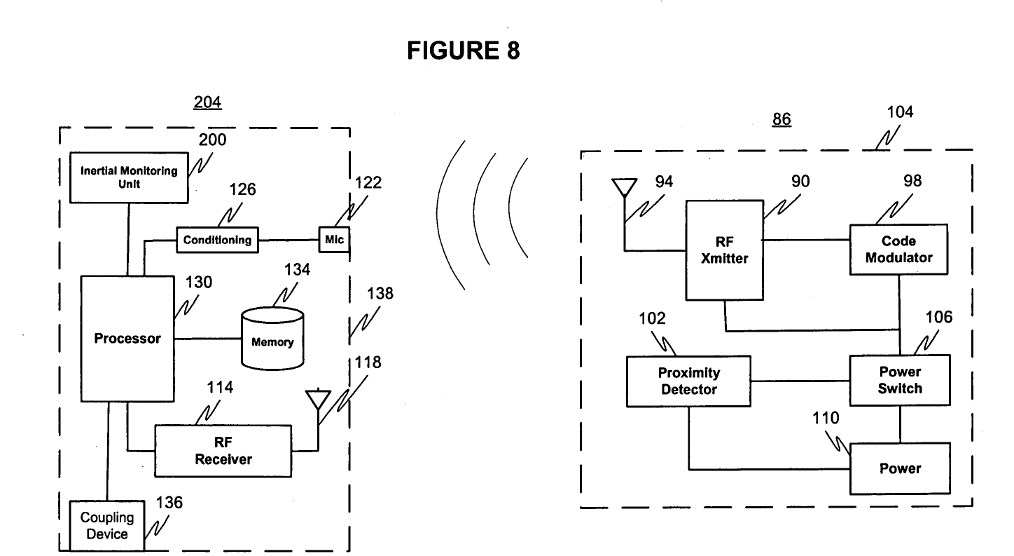

The centralized processor 166 stores the received data in one or more databases from which it is accessed to produce such reports. A relational database for use in storing the downloaded data gathered by monitors 32 in various commercial establishments, for use in producing reports concerning exposure to products in such commercial establishments, is now described with reference to FIGS. 2 and 7. FIG. 7 illustrates a table 170 that stores records identifying the various transmitters, such as transmitter 40 in FIG. 1, employed in the product exposure study by transmitter ID along with the commercial establishment (a store in this illustration) in which it is located and the product it represents. For example, row 178 of table 170 provides an examplary record for a transmitter having ID “8723” present in a fictitious retail store, Ed's Emporium, in the village of Bayville to represent a fictitious product, Champ's Chomp dog food, offered for sale in this store, as well as the distributor or manufacturer of such product. For example, row 178 of FIG. 8 provides an examplary record for a transmitter having transmitter ID “8723” installed in the fictitious retail store mentioned above and at the location of a fictitious product, Champ's Chomp dog food, offered for sale in the store. The record of row 178 also identifies the manufacturer or distributor of the product, here indicated as a fictitious business entity, Dog's Best Friend. Similarly, table 170 includes many other such records, each for a respective transmitter identified by its transmitter ID, and indicating the product it represents, its distributor or manufacturer and the store in which it is offered for sale. It is noted that all of the clients or store owners, as well as the products and their respective manufacturers or distributors listed in table 170, are fictitious and serve only to illustrate exemplary records.

In certain embodiments, the table of FIG. 7 is compiled from data supplied by personnel engaged to place the transmitters in the various commercial establishments participating in the study. In certain embodiments, the data is supplied in written form by such personnel to data entry personnel who populate the table 170 of FIG. 7. Preferably the data is compiled in the table from records communicated from portable electronic devices in the possession of the personnel installing the transmitters in the various participating establishments. Suitable electronic devices for this purpose are disclosed in U.S. patent application Ser. No.______ filed concurrently herewith in the names of Jack K. Zhang and James M. Jensen.

In certain embodiments, the data used to populate the table of FIG. 7 is obtained from the product manufacturers or distributors, and/or from the commercial estabisihments.

As described above, FIG. 2 illustrates a table recording detections of various ones of the transmitters, such as transmitter 40 of FIG. 1, by the monitor 32, along with the times at which each was detected and the duration of continuous detection of the same transmitter's signal. The table of FIG. 2, together with the table of FIG. 7 comprise a relational database providing the ability to map panelist exposures to various products and promotional displays within the participating commercial establishments. It is thus possible to produce reports of various kinds useful to the managers of such commercial establishments as well as the distributors and manufacturers whose products are offered for sale therein.

In certain ones of such reports, the exposure data of FIG. 2 and the data of FIG. 7 are processed to estimate the frequency, duration and density of exposure of consumers to various products and promotional displays within each of the participating establishments whether based on time of day or otherwise.

As noted above, in certain embodiments of the personal monitors 32, not only is such data gathered but also data indicating exposure to media data such as television and radio broadcast exposure, as well as exposure to media displays, both outdoor and indoor. The systems and methods of the present inventions thus provide integrated data estimating not only exposure of consumers to products but also exposure of such consumers to media data and the advertisements conveyed thereby. It is thus possible to evaluate the effects of the exposure to advertising of predetermined individuals to their interest in particular products that may be stimulated by such advertising.

Further embodiments of a system and method for monitoring exposure of a panelist to one or more products within a commercial establishment in accordance with certain embodiments of the present invention are now described. In certain embodiments the receiver 114 of portable monitor 32 (FIG. 4) receives one or more signals from one or more wireless transmitters within or near the commercial establishment, but not associated with particular locations within the commercial establishment, and generates location data indicative of a location of the portable monitor 32 within the commercial establishment based upon the received signals. Such location data is used to assess exposure of the panelist to a product or products at or near the location represented by such location data. In other embodiments, the monitor 32 includes a GPS receiver (not shown for purposes of simplicity and clarity) to obtain such position data in the form of latitude and longitude. In certain advantageous embodiments, the monitor employs an assisted GPS location system.

In certain other embodiments the portable monitor transmits a signal that is received by one or more receiving devices within or near the commercial establishment to determine the location of the portable monitor. In still other embodiments, the portable monitor includes a cellular telephone module (not shown for purposes of simplicity and clarity) that communicates with a cellular telephone system to obtain data therefrom representing the location of the portable monitor 32 based on signals received from the cellular telephone module. Such location data is provided as latitude and longitude or in another usable form. In still further embodiments, the portable monitor 32 employs at least one of the following techniques to generate the location data: an angle of arrival (AOA) technique, a time difference of arrival (TDOA) technique, an enhanced signal strength (ESS) technique, a location fingerprinting technique, and an ultra wideband location technique. From such location data, the exposure of the panelist to one or more products at or near the location represented by the location data is inferred or assessed. Each of these techniques is now briefly described.

The angle of arrival (AOA) technique determines the direction of a signal received from a radio frequency (RF) transmitter. This can be done by pointing a directional antenna along the line of maximum signal strength. Alternatively, signal direction can be determined from the difference in time of arrival of the incoming signals at different elements of the antenna. A two-element antenna is typically used to cover angles of ±60 degrees. To achieve 360-degree coverage, a six-element antenna can be used. However, a single mobile directional antenna can give only the bearing, not the position, of a transmitting object.

With two directional antennas spaced well apart, however, the position of a transmitting device in a plane can be computed. In this method, also known as the angle of arrival (AOA) method, transmitter position is determined from the known (fixed) position of the receivers' antennas and the angle of arrival of the signals with respect to the antennas. In certain embodiments the portable monitor 32 includes a transmitter that enables its location to be determined in accordance with the angle of arrival method.

The time difference of arrival (TDOA) technique is based upon the similar concept that the difference in time of arrival between signals received at antennas at different locations can be used to determine position. Given the speed of light and known transmit and receive times, the distance between a transmitter and the receiver antenna can be calculated. In certain embodiments the portable monitor 32 includes a transmitter that enables its location to be determined in accordance with the time difference of arrival technique.

In an alternative time difference scheme, the monitor and the antennas reverse roles: the antennas are transmitters and the portable monitor 32 incorporates a receiver. This technique is known as forward link trilateration (FLT). This is relatively simple to implement in some code-division multiple access (CDMA) wireless systems, where the time difference of arrival can be determined from the phase difference between pseudo-random noise code sequences of 0s and 1 s transmitted from two antennas. In certain embodiments the portable monitor 32 includes a receiver, such as a CDMA cellular telephone receiver, that enables its location to be determined in accordance with the forward link trilateration method.

When the term “time difference of arrival technique” is used herein, the term is meant to encompass both the traditional time difference of arrival (TDOA) method and the forward link trilateration (FLT) method.

The enhanced signal strength (ESS) method provides improvements over conventional signal strength methods by overcoming such impediments as multipath effects, attenuation, and antenna orientation. The method involves taking in three-dimensional information on the objects, walls, and other features and obstructions within the commercial establishment, and using such information to simulate the RF signal propagation characteristics of wireless transmitting antennas in the area. A location system center stores the results in an RF database. The position of the portable monitor is determined by getting it to measure the signal strength of preferably three to five base transmitters. From this input plus information from the database, the system can calculate the position of the portable monitor. Inside large commercial establishments, such as malls and department stores with appropriate base transmitters located therein, the position of a portable monitor can be determined by means of the ESS method. In certain embodiments the portable monitor 32 includes a receiver that enables its location to be determined in accordance with the ESS method.

The location fingerprinting technique, instead of exploiting signal timing or signal strength, relies on signal structure characteristics. The technique turns the multipath phenomenon to good use by combining the multipath pattern with other signal characteristics, to create a signature unique to a given location. A location fingerprinting system includes a signal signature database of a location grid for a specific area. To generate this database, a device is walked through the area transmitting or receiving signals to or from a monitoring site. The system analyzes the incoming signals, compiles a unique signature for each square in the location grid, and stores it in the database.

To determine the position of a mobile transmitter or receiver, the system matches the transmitter's or receiver's signal signature to an entry in the database. Multipoint signal reception is not required, although it is preferable. The system can use data from only a single point to determine location. In certain embodiments the portable monitor 32 includes a transmitter or a receiver that enables its location to be determined in accordance with the location fingerprinting technique.

In certain ultra wideband location techniques a network of localizers determine relative locations in three-dimensional space by measuring propagation times of pseudorandom sequences of electromagnetic impulses. The propagation time is determined from a correlator which provides an analog pseudo-autocorrelation function sampled at discrete time bins. The correlator has a number of integrators, each integrator providing a signal proportional to the time integral of the product of the expected pulse sequence delayed by one of the discrete time bins, and the non-delayed received antenna signal. Using pattern recognition the arrival time of the received signal can be determined to within a time much smaller than the separation between bins.

In certain ultra wideband techniques, wireless ultra wideband transceivers are positioned at known stationary locations within the area to be monitored, and the portable monitor 32 includes a wireless ultra wideband receiver/processor that receives one or more timed pulses from the various transceivers and resolves the location of the portable monitor within the monitored area based on the locations of the ultra wideband transceivers and time-of-flight measurements of the pulse or pulses. In certain embodiments, the portable monitor 32 includes an ultra wideband transmitter and a plurality of interacting receivers in stationary positions receive a pulse from the transmitter of the portable monitor 32 to determine its location. In certain of the embodiments, the stationary transceivers or receivers are coupled by cabling, while in others they are untethered.

Referring now to FIG. 8, a system is illustrated in block form for measuring the exposure of a panelist to media data and media displays, as well as for monitoring the exposure of a panelist to one or more products within a commercial establishment, in accordance with certain embodiments of the present invention. In FIG. 8, elements corresponding to those of FIG. 4 bear the same reference numerals. Similarly to the system shown in FIG. 4, the system of FIG. 8 includes a portable monitor 204 arranged to be carried on the person of a panelist. The portable monitor 204 receives one or more signals from one or more terrestrial sources and/or satellite sources, and generates data indicative of a location of the portable monitor 204. In certain embodiments, the signals used for this purpose are obtained from a cellular telephone system or from a GPS or assisted GPS receiver, as described above. However, in the system of FIG. 8, the location data is provided by an inertial monitoring device 200 which forms a part of portable monitor 204 and the received signals are used to provide location calibration data to the inertial monitoring device. Such calibration, which is described more fully below, may be performed periodically or from time to time, or whenever the signals from the terrestrial and/or satellite sources are received.

In the embodiment of FIG. 8 the inertial monitoring device 200 of the portable monitor 204 is calibrated by means of a signal transmitted by a calibration transmitter or transmitters 86 located in or in proximity to a commercial establishment in which the movements of the panelist wearing the monitor are to be tracked. Advantageously, in certain embodiments the calibration transmitter or transmitters are located by an entrance or exit of the establishment through which the panelist must pass to enter or leave the commercial establishment. The calibration signal is transmitted at sufficiently low power to ensure that it will be received only when the portable monitor is close by.

The inertial monitoring device preferably is small in size and lightweight. An advantageous embodiment of such an inertial monitoring device employs microelectromechanical sensors (MEMS) as either gyroscopic sensors and/or accelerometers to provide data from which the location of the monitor can be determined.

In certain embodiments to calibrate the inertial monitoring device 200 the portable monitor 204 employs satellite-based techniques, such as global positioning system (GPS) and/or server assisted GPS technology, and/or terrestrial techniques, such as an angle of arrival (AOA) technique, a time difference of arrival (TDOA) technique, an enhanced signal strength (ESS) technique, a location fingerprinting technique, and/or an ultra wideband location technique.

For certain embodiments which gather location data by means of a portable monitor, a database similar to that of FIG. 7 is established but which also stores data indicating locations of the products involved in the market research. The centralized processor 166 of FIG. 6 accesses the product location data from the database along with panelist location data obtained from various portable monitors and processes this data to produce product proximity data indicating exposure of the panelists to the predetermined products. In certain embodiments the processor 166 processes the data to produce the product exposure data based on a comparison of the panelist location data and the product location data. In certain embodiments the processor 166 produces the product proximity data to represent presence of one or more of the panelists in predetermined exposure areas wherein they are able to perceive the predetermined products.

Although various embodiments of the present invention have been described with reference to a particular arrangement of parts, features and the like, these are not intended to exhaust all possible arrangements or features, and indeed many other embodiments, modifications and variations will be ascertainable to those of skill in the art.

1. A method for monitoring exposure to a product of a participant in market research, comprising:
providing a portable monitor comprising a wireless receiver to a respective participant selected from a plurality of participants in the market research study, the portable monitor being adapted to be carried on the person of a participant;
detecting product data in the portable monitor, the product data being contained in a product signal received in the wireless receiver from a predetermined signal transmitter proximal to a respective product, the product data representing the respective product, the product signal having a signal strength selected so that the product data is detectable by the portable monitor only when in a predetermined proximity to the predetermined signal transmitter; and
storing the product data in the portable monitor.

2. The method of claim 1, further comprising detecting commercial establishment data in a commercial establishment signal transmitted wirelessly within a commercial establishment in which the product is located, the commercial establishment data representing the commercial establishment.

3. The method of claim 2, comprising wirelessly receiving the commercial establishment signal.

4. The method of claim 3, comprising receiving the commercial establishment signal as an acoustic signal.

5. The method of claim 4, comprising detecting data in the received commercial establishment signal in the form of an ancillary code inaudibly encoded in an audio signal.

6. The method of claim 4, comprising receiving the product signal as an acoustic signal.

7. The method of claim 6, comprising detecting data both in the product signal and in the commercial establishment signal in the portable monitor as ancillary codes inaudibly encoded in respective audio signals.

8. The method of claim 3, comprising receiving the commercial establishment signal as an RF signal.

9. The method of claim 8, comprising receiving the product signal as an RF signal.

10. The method of claim 9, comprising receiving both the product signal and the commercial establishment signal in the wireless receiver.

11. The method of claim 3, comprising receiving the commercial establishment signal as a light signal.

12. The method of claim 11, comprising receiving the commercial establishment signal as an infrared signal.

13. The method of claim 11, comprising receiving the commercial establishment signal as a visible light signal.

14. The method of claim 11, comprising receiving the product signal as a light signal.

15. The method of claim 1, comprising receiving the product signal as an acoustic signal.

16. The method of claim 15, comprising detecting the product data in the received product signal in the form of an ancillary code inaudibly encoded in an audio signal.

17. The method of claim 1, comprising receiving the product signal as an RF signal.

18. The method of claim 1, comprising receiving the product signal as a light signal.

19. The method of claim 18, comprising receiving the product signal as an infrared signal.

20. The method of claim 18, comprising receiving the product signal as a visible light signal.

21. The method of claim 1, comprising storing first time data on a predetermined time base in association with the product data representing timing of proximity to the product.

22. The method of claim 21, wherein the time data represents a duration of proximity to the product.

23. The method of claim 21, wherein the time data represents a time of proximity to the product.

24. The method of claim 21, comprising gathering media data exposure data in the portable monitor representing exposure of the respective participant to media data and storing the media data exposure data in association with second time data on the predetermined time base representing timing of exposure to the media data.

25. The method of claim 21, comprising gathering outdoor advertising data in the portable monitor representing exposure of the respective participant to outdoor advertising and storing the outdoor advertising data in association with second time data on the predetermined time base representing timing of exposure to the outdoor advertising.

26. The method of claim 1, comprising gathering data in the portable monitor representing exposure of the respective participant to media data.

27. The method of claim 1, comprising gathering data in the portable monitor representing exposure of the respective participant to outdoor advertising.

28. The method of claim 1, wherein the signal strength of the product signal is selected so that the product data is detectable by the portable monitor only when the wireless receiver is located within a predetermined exposure area in which the respective participant is able to perceive the product.

29. The method of claim 1, wherein a sensitivity of the wireless receiver is selected so that the portable monitor is capable of detecting the product data in the product signal only when the wireless receiver is in the predetermined proximity to the predetermined signal transmitter.

30. The method of claim 29, wherein the sensitivity of the wireless receiver is selected so that the portable monitor is capable of detecting the product data in the product signal only when the wireless receiver is located within a predetermined exposure area in which the respective participant is able to perceive the product.

31. A device for monitoring exposure to products by participants in market research, comprising:
a portable monitor adapted to be carried on the person of a participant in the market research study, the portable monitor comprising a wireless receiver operative to receive a product signal from a predetermined signal transmitter proximal to a respective product, the product signal containing product data representing the respective product, the wireless receiver having a sensitivity selected so that the portable monitor is capable of detecting the product data in the product signal only when in a predetermined proximity to the predetermined signal transmitter; and
a data storage coupled with the wireless receiver to receive and store the product data.

32. The device of claim 31, comprising a further wireless receiver operative to detect commercial establishment data in a commercial establishment signal transmitted wirelessly within a commercial establishment in which the product is located, the commercial establishment data representing the commercial establishment.

33. The device of claim 32, wherein the data storage is coupled with the further wireless receiver to receive and store the commercial establishment data.

34. The device of claim 31, wherein the wireless receiver is operative to detect commercial establishment data in a commercial establishment signal transmitted wirelessly within a commercial establishment in which the product is located, the commercial establishment data representing the commercial establishment.

35. The device of claim 34, wherein the data storage is operative to receive and store the commercial establishment data.

36. The device of claim 31, wherein the wireless receiver comprises an RF receiver.

37. The device of claim 36, comprising a processor coupled with the RF receiver to receive the product data therefrom and operative to store the product data in the data storage.

38. The device of claim 31, wherein the wireless receiver comprises an acoustic transducer operative to produce a transduced product signal from an acoustic product signal.

39. The device of claim 38, comprising a processor coupled with the acoustic transducer to receive the transduced product signal and operative to detect the product data therein.

40. The device of claim 31, wherein the wireless receiver comprises a light sensor operative to produce a transduced product signal from a product signal in the form of light energy.

41. The device of claim 40, comprising a processor coupled with the light sensor to receive the transduced product signal and operative to detect the product data therein.

42. The device of claim 31, comprising a media data exposure monitoring device operative to gather media data exposure data in the portable monitor representing exposure of the respective participant to media data, the media data exposure monitoring device being coupled with the data storage to supply the media data exposure data thereto, the data storage being operative to store the media data exposure data.

43. The device of claim 31, comprising an outdoor advertising exposure monitoring device operative to gather outdoor advertising data in the portable monitor representing exposure of the respective participant to outdoor advertising, the outdoor advertising exposure monitoring device being coupled with the data storage to supply the outdoor advertising data thereto, the data storage being operative to store the outdoor advertising data.

44. The device of claim 31, comprising a clock operative to produce first time data on a predetermined time base and coupled with the data storage to supply the time data thereto, the data storage being operative to store the first time data in association with the product data representing a timing of proximity to the respective product.

45. The device of claim 44, comprising a media data exposure monitoring device operative to gather media data exposure data in the portable monitor representing exposure of the respective participant to media data, the media data exposure monitoring device being coupled with the data storage to supply the media data exposure data thereto, the data storage being operative to store the media data exposure data in association with second time data on the predetermined time base received from the clock and representing a timing of exposure to the media data.

46. The device of claim 44, comprising an outdoor advertising exposure monitoring device operative to gather outdoor advertising data in the portable monitor representing exposure of the respective participant to outdoor advertising, the outdoor advertising exposure monitoring device being coupled with the data storage to supply the outdoor advertising data thereto, the data storage being operative to store the outdoor advertising data in association with second time data on the predetermined time base received from the clock and representing a timing of exposure to the outdoor advertising.

47. The device of claim 31, wherein the sensitivity of the wireless receiver is selected so that the portable monitor is capable of detecting the product data in the product signal only when the wireless receiver is located within a predetermined exposure area in which the respective participant is able to perceive the product.

48. A method for monitoring exposure to a predetermined product of a participant in market research, comprising:
storing product location data representing a location of a predetermined product;
monitoring a location of a participant in market research by means of a portable monitor carried on the person of the participant;
storing participant location data representing a plurality of locations of the participant monitored by means of the portable monitor; and
processing the participant location data and the product location data to produce product proximity data indicating exposure of the participant to the predetermined product.

49. The method of claim 48, comprising storing first time data on a predetermined time base in association with the participant location data representing timing of the participant's presence at the plurality of locations.

50. The method of claim 49, wherein the time data represents durations of presence at the plurality of locations.

51. The method of claim 49, wherein the first time data represents a times of presence at the plurality of locations.

52. The method of claim 49, comprising gathering media data exposure data in the portable monitor representing exposure of the participant to media data in association with second time data on the predetermined time base representing timing of exposure to the media data.

53. The method of claim 49, comprising gathering outdoor advertising data in the portable monitor representing exposure of the participant to outdoor advertising and storing the outdoor advertising data in association with second time data on the predetermined time base representing timing of exposure to the outdoor advertising.

54. The method of claim 48, comprising gathering data in the portable monitor representing exposure of the participant to media data.

55. The method of claim 48, comprising gathering data in the portable monitor representing exposure of the participant to outdoor advertising.

56. The method of claim 48, wherein processing the participant location data and product location data comprises comparing the participant location data with the product location data to produce the product proximity data.

57. The method of claim 48, wherein processing the participant location data and the product location data comprises producing the product proximity data to represent a presence of the participant within a predetermined exposure area in which the participant is able to perceive the product.

58. The method of claim 48, comprising determining a presence of the participant in a commercial establishment in which the predetermined product is offered for sale.

59. A system for monitoring exposure of a participant in market research to a predetermined product, comprising:
a database storing product location data representing a location of a predetermined product;
a portable monitor adapted to be carried on the person of a participant in market research and comprising a position monitor operative to produce participant location data representing a location of the participant and a data storage coupled with the position monitor to receive the participant location data and operative to store the participant location data; and
a processor coupled with the portable monitor to receive the participant location data therefrom and operative to access the product location data from the database;
the processor serving to process the participant location data and the product location data produce product proximity data indicating exposure of the participant to the predetermined product.

60. The system of claim 59, wherein the processor is operative to compare the participant location data with the product location data to produce the product proximity data.

61. The system of claim 59, wherein the processor is operative to produce the product proximity data to represent a presence of the participant within a predetermined exposure area in which the participant is able to perceive the product.

62. The system of claim 59, wherein the processor is coupled with the portable monitor through a communications network.

63. The system of claim 59, wherein the portable monitor comprises a clock operative to produce first time data on a predetermined time base and coupled with the data storage to provide the first time data thereto, the data storage being operative to store the first time data in association with the participant location data representing timing of the participant's presence at the plurality of locations.

64. The system of claim 59, wherein the portable monitor further comprises a media data monitor operative to gather media data exposure data representing exposure of the participant to media data.

65. The system of claim 64, wherein the data storage is coupled with the media data monitor to receive the media data exposure data and is operative to store the media data exposure data in association with second time data on the predetermined time base representing time of exposure to the media data.

66. The system of claim 59, wherein the portable monitor comprises an outdoor advertising exposure monitor operative to gather outdoor advertising data representing exposure of the participant to outdoor advertising.

67. The system of claim 66, wherein the data storage is coupled with the outdoor advertising exposure monitor to receive the outdoor advertising data and is operative to store the outdoor advertising data in association with second time data on the predetermined time base representing time of exposure to the outdoor advertising.
